(19) United States
(12) Patent Application Publication
(10) Pub. No.: US 2005/0148220 A1
(43) Pub. Date: Jul. 7, 2005

(54) Card edge connector

(76) Inventor: Tung-Chang Lin, Taipei Hsien (TW)

Correspondence Address: MOLEX INCORPORATED, 2222 WELLINGTON COURT, LISLE, IL, 60532, US

(21) Appl. No.: 11/014,923

(22) Filed: Dec. 17, 2004

(30) Foreign Application Priority Data
Dec. 19, 2003 (TW) 92222268

(51) Int. Cl. H01R 4/66

(52) U.S. Cl. 439/108

(57) ABSTRACT

A card edge connector includes an insulative housing, a plurality of terminals and two latches. The insulative housing has a main body and two lateral side frames. The terminals are disposed on the main body of the insulative housing. The two latches are individually disposed on two free ends of the two lateral side frames of the insulative housing, and has two base portions. Wherein each base portion has a stopper extended from a front side of the base portion, an elastic arm connected with a rear side of the base portion, and a pushed portion extended from a free end of the elastic arm to the stopper. When the two pushed portions are individually pushed outwardly, the two pushed portions interfere with the corresponding stopper for limiting an outward pushing distance of the elastic arm.

### FIELD OF THE INVENTION

The present invention relates to a card edge connector, and particularly relates to a card edge connector disposed on a motherboard for receiving and electrically connecting to a daughterboard having card-retaining latches that provide extra protection against breakage.

### DESCRIPTION OF THE RELATED

Referring to FIGS. 1 and 2, a conventional card edge connector, disposed on an upper surface of a motherboard, is disclosed. The card edge connector is used for receiving a daughterboard so as to electrically connect the motherboard.

The card edge connector includes an insulative housing 91, a plurality of terminals 92 and two latches 93. The insulative housing 91 includes a main body 911 and two lateral frames 912 connecting the main body 911. The terminals 92 are arranged on the main body 911 of the insulative housing 91, and each of the terminals 92 has a pin portion 921 connecting to a pad of the motherboard for electrical connection. When the daughterboard inserts between the two lateral frames 912 of the insulative housing 91, the daughterboard electrically connects the terminals 92. Each of the two lateral frames 912 has a latching portion 913 formed at a free end thereof for resiliently locking the daughterboard.

The two latches 93 are disposed on the two lateral frames 912, and are made of the metallic materials. Each metallic sheath 93 has a main portion 931, which is “U” shaped in order to match each lateral frame 912. The main portion 931 extends forwards and a limiting portion 932 projecting upwardly is formed, so that the lateral sidewall of the main portion 931 and the limiting portion 932 restrain the outward and inward distances of the two lateral frames 912, respectively.

However, the latches 93 of the conventional card edge connector are elongated, so that the sidewall of the main portion 931 of the two latches 93 cannot restrain the outward distance of the two lateral frames 912 exactly when the daughterboard is ejected and the two lateral frames 912 are moved outwardly so as to enable the latching portion 913 remove form the daughterboard. The two lateral frames 912 move outwardly and vibrate so much may lead to the deformation or breakage of the two lateral frames 912, which are made of plastic materials.

### SUMMARY OF THE INVENTION

The primary objective of the invention is therefore to specify a card edge connector that can directly push two elastic arms of two latches to move with a predetermined outward pushing distance and prevent the breakage or deformation from the two lateral frames and the two latches effectively.

In order to achieve the above objectives, the present invention provides a card edge connector including an insulative housing, a plurality of terminals and two latches. The insulative housing has a main body and two lateral side frames. The terminals are disposed on the main body of the insulative housing. The two latches are individually disposed on two free ends of the two lateral side frames of the insulative housing, and have two base portions. Wherein each base portion has a stopper extended from a front side of the base portion, an elastic arm connected with a rear side of the base portion, and a pushed portion extended from a free end of the elastic arm to the stopper. When the two pushed portions are individually pushed outwardly, the two pushed portions interfere with the corresponding stopper for limiting an outward pushing distance of the elastic arm.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a card edge connector of the prior art;

FIG. 2 is a front view of a card edge connector of the prior art;

FIG. 3 is a perspective, exploded view of a card edge connector of the present invention;

FIG. 4 is another perspective, exploded view of a card edge connector of the present invention;

FIG. 5 is a perspective, assembled view of a card edge connector of the present invention;

FIG. 6 is a front view of a card edge connector of the present invention; and

FIG. 7 is a perspective view of when a card edge connector receives a daughterboard according to the present invention;

FIG. 8 is a front view of when a card edge connector receives a daughterboard according to the present invention;

FIG. 9 is a perspective, exploded view of a lateral frame and a latches according to another embodiment of the present invention; and

FIG. 10 is a perspective, assembled view of a lateral frame and latches according to another embodiment of the present invention.

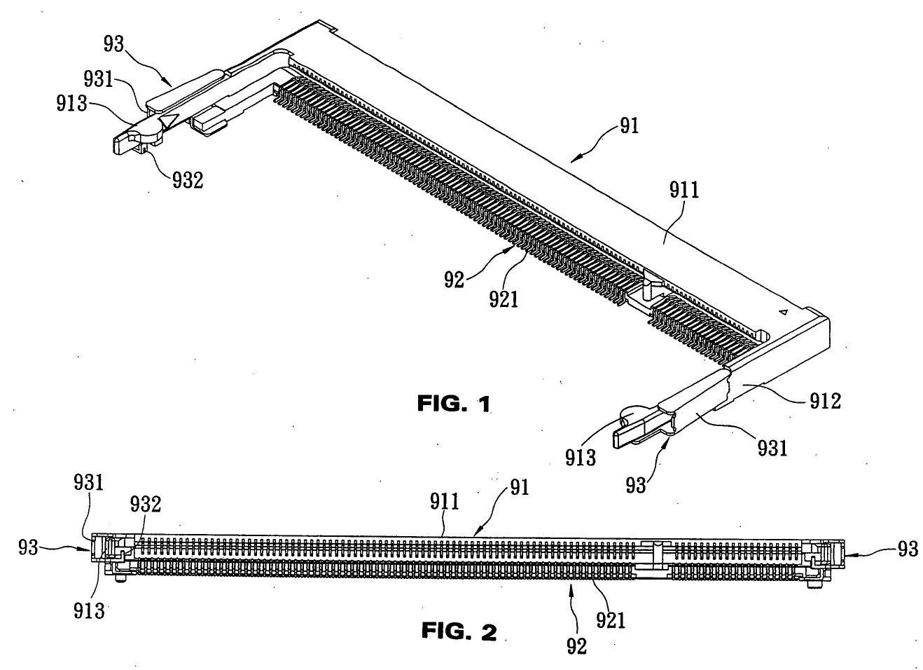

### DETAILED DESCRIPTION OF THE DISCLOSED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

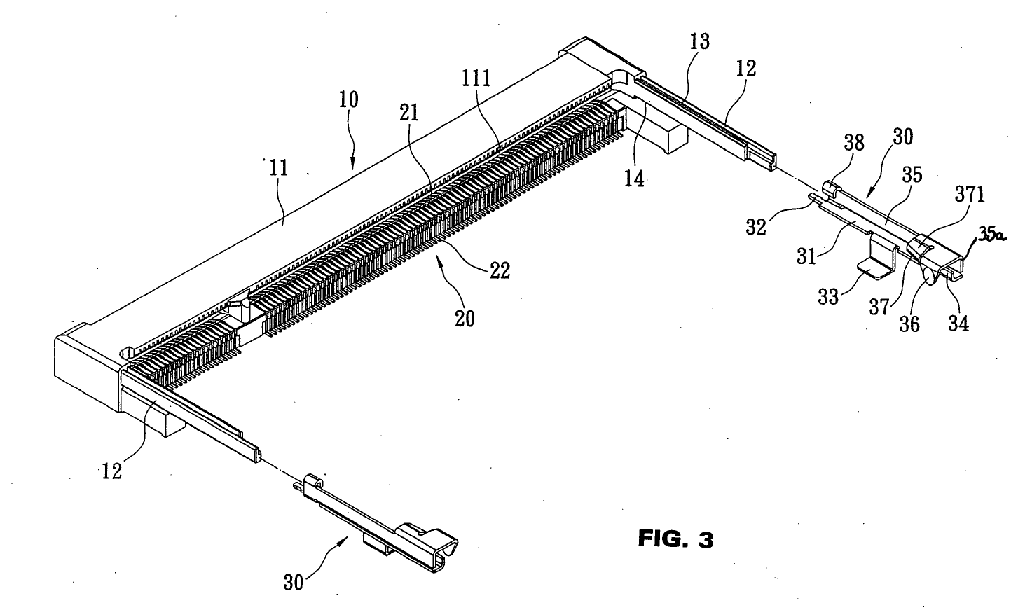

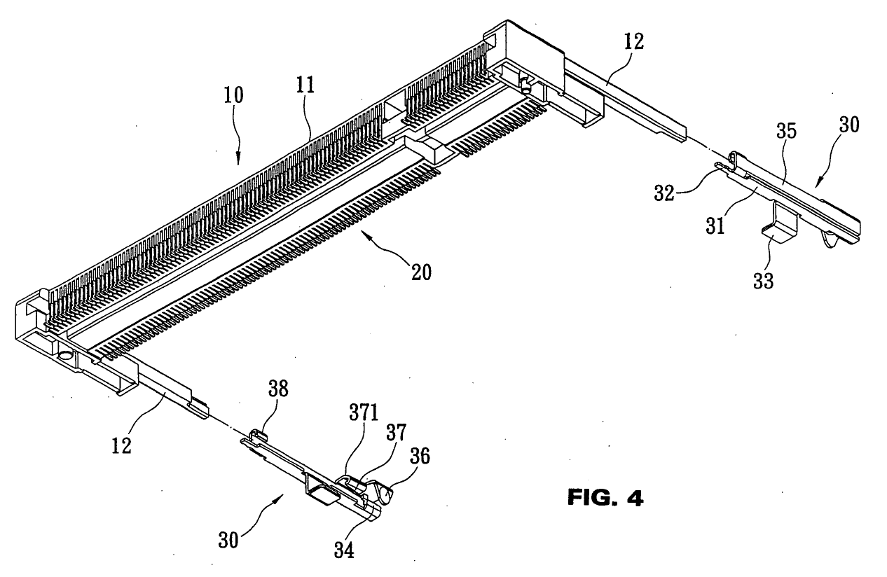

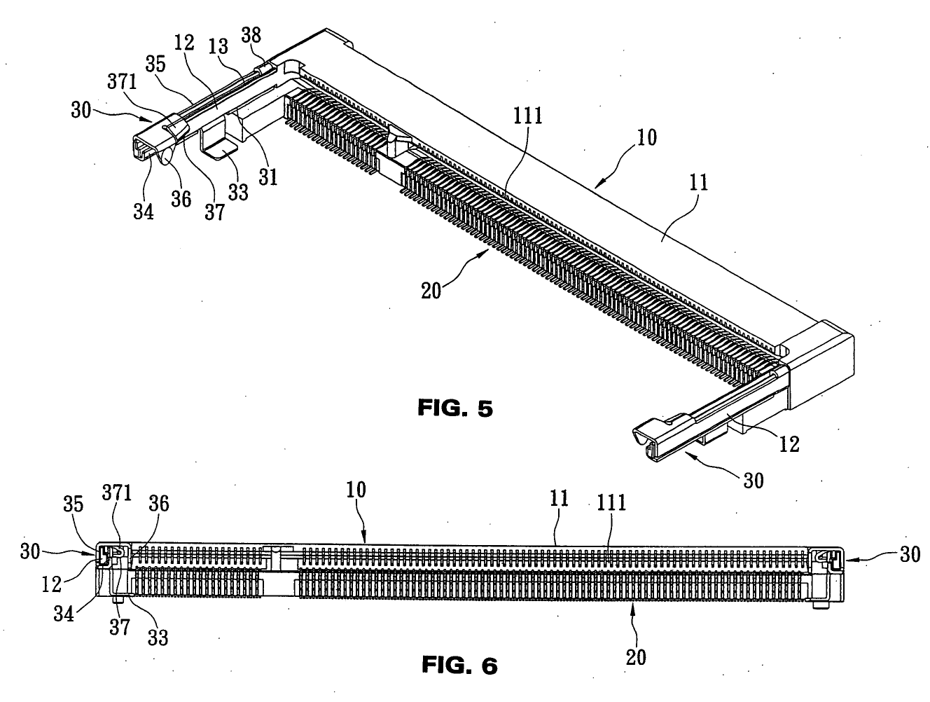

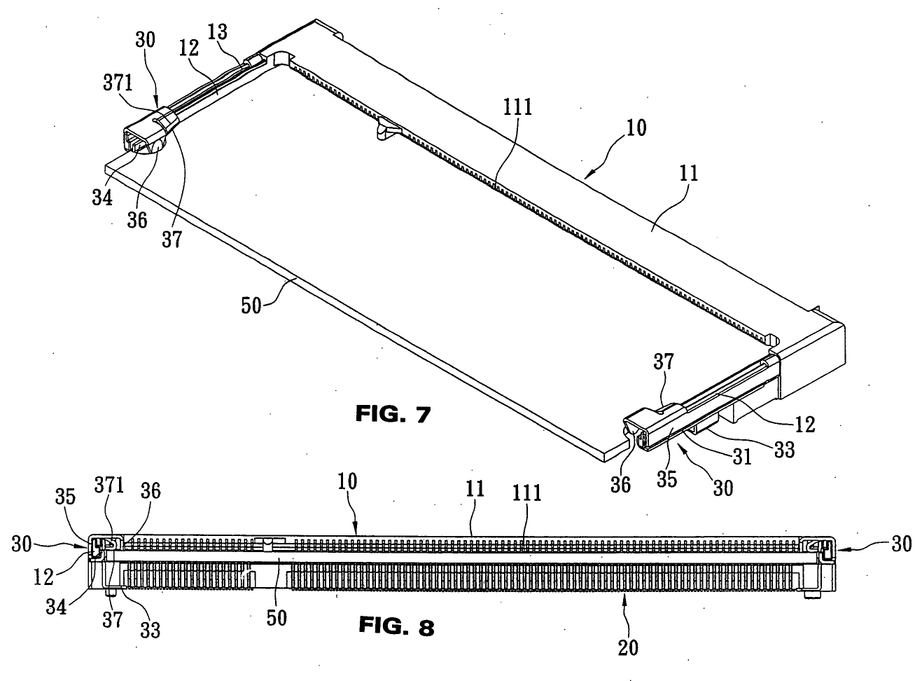

A card edge connector illustrated in FIGS. 3-6 according to the present invention is disposed on an upper surface of a motherboard (not shown in Fig) for receiving and electrically connecting a daughterboard 50 (as FIGS. 7-8), so as to electrically connect the motherboard and the daughterboard 50 together.

The card edge connector includes an insulative housing 10, a plurality of terminals 20 and two latches 30. The insulative housing 10 is made of plastic materials, and includes a main body 11 and two lateral frames 12 integrally connecting with the main body 11. The main body 11 includes a reception opening 111 for receiving one side of the daughterboard 50. Each lateral frame 12 has a concave groove 13 formed at a front side and bottom side thereof for firmly fixing the two latches 30 on the two lateral frames 12, respectively.

The terminals 20 are disposed on the main body 11 of the insulative housing 10; each of the terminals 20 includes a contact portion 21 and a pin portion 22. The contact portion 21 is disposed inside the reception opening 111 of the insulative housing 11 for electrically connecting a pad of the daughterboard 50. The pin portion 22 extends outwardly from the main body 11 for soldering with a pad of the motherboard for electrical connection. When the daughterboard 50 is inserted into the card edge connector, the daughterboard 50 electrically connects with the motherboard.

The latches 30 are individually mounted on a free end of two lateral frames 12 of the insulative housing 10. The latch 30 is punched by metallic material. Each latch 30 includes a base portion 31, which is elongated. A fixed portion 32 and a solder portion 33 are extended from a rear side and an inner side of the base portion 31, respectively. The fixed portion 32 is embedded into the corresponding fixed groove 14 of the lateral frame 12. The fixed portion 32 firmly connects to the lateral frame 12 by an interference method, so as to firmly fix the base portion 31 on the lateral frame 12. The solder portion 33 is bended to form a L-shaped, and disposed at lower place for soldering and fixing on the motherboard.

A hook element 38 is upward and inward formed at a rear side of the base portion 31. The hook element 38 can be inserted into the concave groove 13 for increasing fixity, so as to firmly position the two latches 30 on the two lateral frames 12, and prevent the latch 30 from sliding easily.

Each of the latches 30 has a stopper 34 extended from a front side of the base portion 31. The stopper 34 is inserted into the lateral frame 12. Each of the latches 30 has an elastic arm 35 connected with a rear side of the base portion 31. The elastic arm 35 has a free end 35a that can be moved inwardly and outwardly.

A pushed portion 36 and a latching portion 37 are inward and downward extended from a free end of the elastic arm 35 to the stopper 34. The pushed portion 36 is disposed at an inner side relative to the stopper 34. The latching portion 37 has a guiding inclined face 371 formed at a top edge thereof. The latching portion 37 resiliently locks with the daughterboard 50 for guiding the daughterboard 50.

The pin portion 22 of each terminal 20 and the solder portion 30 of each latch 30 solder to the upper surface of the motherboard for electrical connection. The card edge connector is used to receive the dautherboard 50 (as the FIGS. 7 and 8). When the daughterboard 50 is slantwise inserted into the reception opening 111 of the insulative housing 10, the daughterboard 50 is smooth downward pressed by the guiding inclined face 371, so as to dispose two sides of the dautherboard 50 under the latching portion 37. The two latching portions 37 of the two latches 30 limits the daughterboard 50 to move, so as to the daughterboard 50 is firmly inserted into the insulative housing 10. The pin portion 21 of each contact 20 electrically connects the daughterboard 50, so as to enable the daughterboard 50 electrically connect the motherboard.

When the user wants to eject the daughterboard 50, the two pushed portions 36 can be moved outwardly to release the daughterboard 50 from the latching portion 37 for drawing out the daughterboard 50 easily. When the elastic arms 35 outwardly moved in a predetermined distance, the pushed portion 36 interferes with the stopper 34 for positioning. Because the stopper 34 and the base portion 31 are fixed on the lateral frame 12 of the insulative housing 10, the pushed portion 36 interferes with the stopper 34 for limiting the outward pushing distance of the elastic arm 35 of the latch 30. Therefore, the elastic arm 35 will not be overextended.

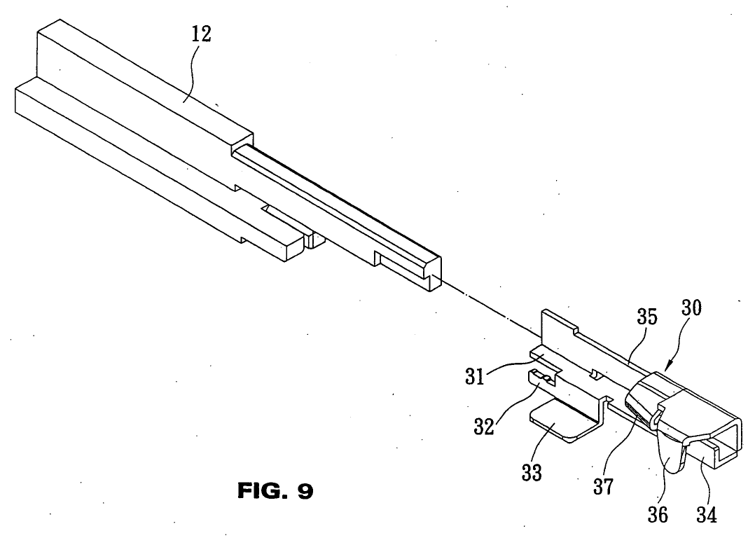

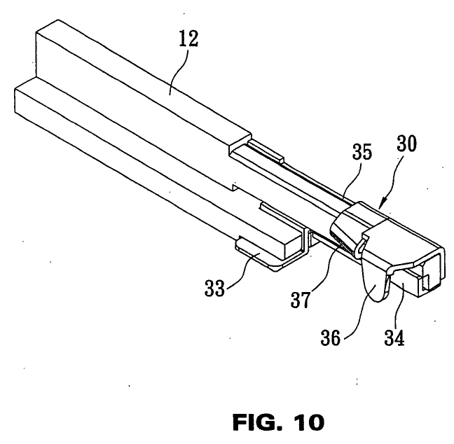

Moreover, referring to the FIGS. 9 and 10, another embodiment of the present invention can omit the hook element 38 of the latch 30 and the concave groove 13 of the lateral frame 12.

The card edge connector can directly push two elastic arms 35 of two latches 30 to move in a predetermined outward pushing distance and prevent the break or the formation from the two lateral frames 12 and the two latches 30 effectively.

While a preferred embodiment of the present invention is shown and described, it is envisioned that those skilled in the art may devise various modifications of the present invention without departing from the spirit and scope of the appended claims.

1. A card edge connector comprising:
an insulative housing having a main body and at least one lateral side frame;
a plurality of terminals disposed on the main body of the insulative housing; and
a latch disposed on a free end of the lateral side frame of the insulative housing, the latch including a base portion, the base portion having a stopper extended from a front side of the base portion, an elastic arm connected with a rear side of the base portion, and a pushed portion extended from a free end of the elastic arm to the stopper; and
whereby, when the pushed portion is pushed outwardly, the pushed portions interfere with the corresponding stopper for limiting the outward travel distance of the elastic arm.

2. The card edge connector as claimed in claim 1, wherein the latch has a hook element, the lateral frame has a concave groove, and the hook element is fixed and inserted in the concave groove.

3. The card edge connector as claimed in claim 1, wherein the latch has a latching portion extended from the free end of the elastic arm to the stopper for resiliently locking with the daughterboard.

4. The card edge connector as claimed in claim 3, wherein the latching portion has a guiding inclined face formed at an upper edge thereof.

5. The card edge connector as claimed in claim 1, wherein the latch has a fixed portion extended from the base portion, and the fixed portion is embedded into a corresponding fixed groove of the lateral frame.

6. The card edge connector as claimed in claim 1, wherein the latch has a solder portion extended from the base portion for soldering and fixing on the motherboard.

7. The card edge connector as claimed in claim 1, wherein the stopper is disposed at a front side of the base portion.

8. The card edge connector as claimed in claim 1, wherein the pushed portion is inward and downward bended from a free end of the elastic arm.

9. The card edge connector as claimed in claim 1, wherein the insulative housing has two lateral side frames.

10. The card edge connector as claimed in claim 9, wherein each of the lateral frames include a latch.

11. The card edge connector as claimed in claim 9, wherein the insulative housing includes a main body, and wherein the main body is located between the two lateral side frames.
